(19) United States
(12) Patent Application Publication
(10) Pub. No.: US 2025/0282363 A1
(43) Pub. Date: Sep. 11, 2025

(54) COMPUTER-IMPLEMENTED METHOD FOR BEHAVIOR PLANNING OF A VEHICLE, PROCESSING DEVICE AND VEHICLE CONTROL DEVICE

(71) Applicant: Robert Bosch GmbH, Stuttgart (DE)

(72) Inventor: Andreas Heyl, Weil Der Stadt (DE)

(21) Appl. No.: 19/069,837

(22) Filed: Mar. 4, 2025

(30) Foreign Application Priority Data
Mar. 11, 2024 (DE) 10 2024 202 233.0

(51) Int. Cl. B60W 50/00; G07C 5/02

(52) U.S. Cl. CPC B60W 50/0098; G07C 5/02

(57) ABSTRACT

A computer-implemented method for behavior planning of a vehicle. The method includes: ascertaining at least one planned driving behavior of the vehicle depending on an environmental perception of a vehicle environment of the vehicle, ascertaining at least one spatially resolved degree of importance of a functional impairment of the environmental perception and a spatially resolved perception capability of the environmental perception, in each case in relation to the planned driving behavior, ascertaining a risk of the functional impairment of the environmental perception for the planned driving behavior at least depending on the degree of importance and the perception capability, ascertaining a risk of the planned driving behavior for the vehicle and/or the vehicle environment depending on the risk of the functional impairment, calculating the driving behavior to be applied depending on the planned driving behavior and the risk of the planned driving behavior.

### FIELD

The present invention relates to a computer-implemented method for behavior planning of a vehicle. The present invention further relates to a processing device and to a vehicle control device.

### BACKGROUND INFORMATION

Risk analysis for vehicle automated driving systems is critical to the operation of autonomous or automated vehicles. Risk analysis includes the systematic identification, assessment and prioritization of risks that may arise from the interaction of the vehicle with the vehicle environment. Assessing the risk of a planned driving behavior of the vehicle for the vehicle and/or its environment is critical. This risk assessment allows for early detection of potential hazards caused by planning errors.

U.S. Patent Application Publication NO. US 2022/0315052 A1 describes a risk assessment of driving situations of an autonomous vehicle, which uses the probability of hazardous traffic situations and the probability of relevant system errors to determine an estimated probability of occurrence of critical events for a certain period of time.

The risk of a driving situation or driving behavior depends on the severity, the probability of occurrence of the risk event, the controllability of the risk event, and the probability of a system failure. The ISO 26262 standard plays an essential role in defining the safety requirements for electrical and/or electronic systems in vehicles, including the definition of safety integrity levels aimed at reducing risk to an acceptable level. The probability of system failure in the context of autonomous or automated driving systems requires a continuous assessment of the probability of errors in the functions of environmental perception, planning and actuation, according to ISO 21448 (SOTIF). This assessment must be dynamic and context-dependent to ensure the safety and reliability of the system under all operating conditions.

### SUMMARY

According to the present invention, a computer-implemented method for behavior planning of a vehicle is provided. According to an example embodiment of the present invention, the method includes: ascertaining at least one planned driving behavior of the vehicle depending on an environmental perception of a vehicle environment of the vehicle; ascertaining at least one spatially resolved degree of importance of a functional impairment of the environmental perception and a spatially resolved perception capability of the environmental perception, in each case in relation to the planned driving behavior; ascertaining a risk of the functional impairment of the environmental perception for the planned driving behavior at least depending on the degree of importance and the perception capability; ascertaining a risk of the planned driving behavior for the vehicle and/or the vehicle environment depending on the risk of the functional impairment; and calculating the driving behavior to be applied depending on the planned driving behavior and the risk of the planned driving behavior. This allows the vehicle's behavior to be planned depending on spatially resolved circumstances and conditions. The risk of functional impairment can be ascertained more precisely.

The risk of the driving behavior to be implemented can be better assessed. Behavior planning can be more appropriate to the situation. The driving safety of the vehicle is increased.

The vehicle can be a motor vehicle, a truck, a two-wheeled vehicle, a mobile robot or an industrial robot. The vehicle can assume at least a partially autonomous or autonomous operating state during driving.

According to an example embodiment of the present invention, the behavior planning can include planning a driving behavior of the vehicle, in particular at least one movement trajectory of the vehicle.

Environmental perception may require environmental detection. The environmental detection can be carried out by collecting and processing environmental sensor data from at least one environmental sensor of the vehicle. The environmental sensor can be a LIDAR sensor, a radar sensor, an ultrasonic sensor and/or a camera. The environmental perception can process and interpret the environmental sensor data provided by the at least one environmental sensor. Machine learning and image processing techniques can be used in the environmental perception, in particular to recognize patterns in the environmental sensor data and/or to classify the at least one environmental object. Environmental perception can include the creation of an environmental model of the vehicle environment.

The environmental perception can have at least one environmental perception function. The environmental perception function can include color recognition, object detection and/or object classification of at least one environmental object.

The perception capability can be a performance capability, for example spatial resolution or detection performance, of the environmental perception. The perception capability can depend on the probability of a functional impairment of the environmental perception.

According to an example embodiment of the present invention, the degree of importance of the functional impairment in relation to the planned driving behavior can indicate an extent of the functional impairment of driving safety and/or vehicle safety of the vehicle in the planned driving behavior.

The risk of functional impairment for the planned driving behavior can be proportional to the degree of importance of the functional impairment. The risk of functional impairment can be inversely proportional to the perception capability of the environmental perception. The risk of functional impairment can also be spatially resolved.

The vehicle environment present during the planned driving behavior can have at least one environmental object. The environmental object can be a building, a living being, a device, an object, another vehicle, a plant or a road condition of a roadway on which the vehicle is driving.

According to an example embodiment of the present invention, the planned driving behavior can comprise discrete parameters, such as trajectory, lane guidance, lane changes and/or braking. The planned driving behavior can depend on driving parameters of the vehicle, in particular target speed, target point, acceleration, braking, acceleration gradient, braking gradient, steering angle, and/or steering angle gradient. The planned driving behavior can comprise at least one risk-minimized driving maneuver (MRM).

The planned driving behavior can be ascertained at predetermined time intervals, for example every 200 ms.

According to an example embodiment of the present invention, the functional impairment of the environmental perception can be a performance limitation, for example a malfunction of the environmental perception. The malfunction can, for example, consist in not detecting or recognizing an environmental object, or detecting it too late and/or incorrectly. The malfunction can be a malfunction of at least one environmental perception function of the environmental perception. The malfunction can be a false positive detection, a false negative detection, an incorrect bounding box, an incorrect class and/or an incorrect or late detection.

The functional impairment can occur randomly, for example due to electrical and/or electronic errors, and/or systematically. The functional impairment, which occurs in particular systematically, can arise depending on occurrence events, for example internal and/or external influences, in particular of the vehicle environment. The external occurrence events can comprise environmental conditions, in particular road conditions, weather conditions and/or object states or object interactions of surrounding objects. The internal occurrence events can comprise system conditions, system states or interactions within the vehicle's system, such as computing power, storage capacity, transmission power, synchronization, latencies, electrical, electronic and/or thermal conditions.

The degree of importance and/or the perception capability can be ascertained using models, in particular via machine learning.

According to an example embodiment of the present invention, the risk of functional impairment can be ascertained depending on the environmental perception function of the environmental perception. The risk of functional impairment can be ascertained using models, in particular via machine learning.

The ascertainment of the risk of the driving behavior can be carried out before, after or at the same time as the ascertainment of the degree of importance, the perception capability and/or the risk of functional impairment.

In a preferred embodiment of the present invention, it is advantageous if the degree of importance and/or the perception capability is ascertained depending on the driving situation and/or vehicle environment. The degree of importance and/or the perception capability can be ascertained depending on the at least one environmental perception function of the environmental perception.

The degree of importance, perception capability and/or risk of functional impairment can be ascertained depending on environmental information, in particular map data, vehicle-to-vehicle communication (V2V) and/or information from infrastructure facilities.

In a preferred embodiment of the present invention, the degree of importance and/or the perception capability is ascertained so as to be spatially resolved into spatial zones of the vehicle environment. The risk of functional impairment of an environmental perception function can be higher in some spatial zones of the vehicle environment than in others. For example, when color recognition is used as an environmental perception function, the risk of functional impairment for the vehicle and/or the vehicle environment in spatial zones including a traffic light and possibly also spatial zones bordering the traffic light can be higher than in spatial zones outside of it. When free space detection is used as an environmental perception function, the risk of functional impairment for the vehicle and/or the vehicle environment can be higher in spatial zones immediately in front of the vehicle than in spatial zones outside of it. When lateral motion detection is used as an environmental perception function, the risk of functional impairment for the vehicle and/or the vehicle environment to the side of the vehicle can be higher than in spatial zones outside of it.

The spatial zones can be divided by a grid structure, in particular a three-dimensional one.

In a special embodiment of the present invention, it is advantageous if the degree of importance and/or the perception capability is ascertained depending on the environmental conditions of the vehicle. The environmental conditions can be weather conditions, visibility conditions and/or road conditions.

In a preferred embodiment of the present invention, the risk of the driving behavior associated with at least one risk event is further ascertained depending on a degree of importance of the risk event, a probability of occurrence of the risk event, and/or a controllability of the risk event. The risk event can comprise a violation, exceedance, and/or non-compliance with specifications, for example spatial references. The spatial references can be static or dynamic and/or constant or changing. The static and constant spatial references can be road markings and/or road boundaries. The static variable spatial references can be traffic signs and/or traffic lights. The dynamic static spatial references can be distances to less dynamic road users, such as pedestrians. The dynamic variable spatial references can be distances to more dynamic road users, such as other vehicles.

The degree of importance of the risk event can depend on a mass and/or a speed of the vehicle and/or of the at least one environmental object associated with the risk event.

The probability of occurrence of the risk event can comprise a trajectory probability of road users and/or a braking probability of other vehicles.

Controllability can be influenced by the behavior of other road users.

In a preferred embodiment of the present invention, it is advantageous if the risk of the driving behavior is indicated by at least one risk parameter. The risk parameter can refer to a spatial zone, a group of spatial zones, an environmental event, a sequence of environmental events and/or a time period. The parameterization of the risk of the driving behavior can be selected depending on the vehicle type.

The risk of functional impairment for the planned driving behavior can also be indicated by another risk parameter.

In a special embodiment of the present invention, it is advantageous if the driving behavior to be applied is changed so as to deviate from the planned driving behavior if the risk parameter exceeds a limit value. The driving behavior to be applied can correspond to the planned driving behavior if the risk parameter falls at least below a limit value. A reverse assessment with respect to the risk parameter can also be possible.

In a preferred embodiment of the present invention, it is advantageous if, in addition to the ascertained planned driving behavior, at least one planned second driving behavior is ascertained as the first driving behavior, in relation to which planned second driving behavior the risk of functional impairment and the risk of the planned second driving behavior are ascertained analogously to the first driving behavior and the calculation of the driving behavior to be applied includes a selection from the first and second driving behaviors depending on the risk of the planned driving behavior in question. The risk of the second driving behavior can be indicated by at least one further risk parameter. The driving behavior to be applied can be calculated depending on the risk parameter and the further risk parameter. The driving behavior to be applied can be calculated depending on the risk parameter and the additional risk parameter as well as the limit value. The planned first and second driving behaviors can comprise in total at least one set of trajectories.

If the risk parameter and the further risk parameter are both below the limit value, the driving behavior to be applied can be selected from the first and second driving behaviors depending on a benefit or expediency for the vehicle and/or the vehicle environment. If the risk parameter and the further risk parameter are both above the limit value, the driving behavior to be applied can be selected according to the lowest value in the comparison between the risk parameter and the further risk parameter, in particular additionally taking into account the expediency and/or benefit of the corresponding driving behavior for the vehicle and/or the vehicle environment.

The present invention further relates to a non-transitory, computer-readable medium containing instructions, the execution of which causes at least one processor to execute the computer-implemented method having at least one of the above-described features of the present invention.

According to the present invention, a processing device is also proposed. The processing device can comprise at least one processor for at least partially executing the method of the present invention.

According to the present invention, a vehicle control device is also provided. The vehicle control device can be a control unit or part of a control unit of the vehicle. Adjusting the driving behavior to be applied can comprise initiation, control and/or actuation for the implementation of the driving behavior to be applied. The vehicle control device can comprise a processing device.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows a computer-implemented method for behavior planning in an example embodiment of the present invention.

FIG. 2A to 9C show a particular driving situation when the method for behavior planning is carried out in a further example embodiments of the present invention.

### DETAILED DESCRIPTION OF EXAMPLE EMBODIMENTS

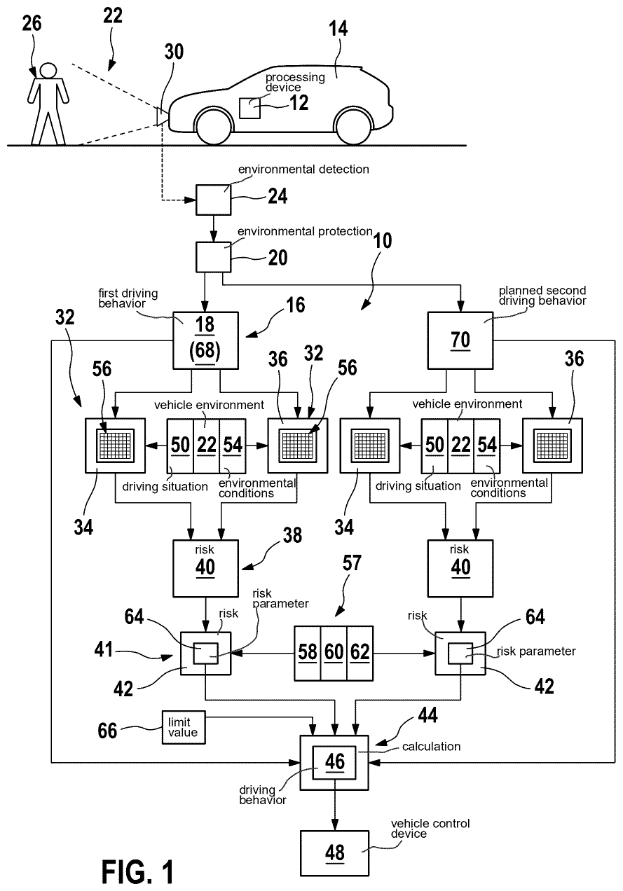

FIG. 1 shows a computer-implemented method for behavior planning in a special embodiment of the present invention. The computer-implemented method 10 for behavior planning of a vehicle can be carried out by a processing device 12 in the vehicle 14 and comprises at least ascertaining 16 at least one planned driving behavior 18 of the vehicle 14 depending on an environmental perception 20 of a vehicle environment 22 of the vehicle 14. The environmental perception 20 may require environmental detection 24 of environmental objects 26 in the vehicle environment 22 by at least one environmental sensor 30 of the vehicle 14.

Furthermore, the method comprises ascertaining 32 at least one spatially resolved degree of importance 34 of a functional impairment of the environmental perception 20 and a spatially resolved perception capability 36 of the environmental perception 20, in each case in relation to the planned driving behavior 18. The functional impairment of the environmental perception 20 can be a performance limitation, for example a malfunction of the environmental perception 20. The degree of importance 34 of the functional impairment in relation to the planned driving behavior 18 can indicate an extent of the functional impairment of driving safety and/or vehicle safety in the planned driving behavior 18. The perception capability 36 can be a performance capability, for example spatial resolution or detection performance, of the environmental perception 20.

Furthermore, the method comprises ascertaining 38 a risk 40 of the functional impairment of the environmental perception 20 for the planned driving behavior 18 at least depending on the degree of importance 34 and the perception capability 36, ascertaining 41 a risk 42 of the planned driving behavior 18 for the vehicle 14 and/or the vehicle environment 22 depending on the risk 40 of the functional impairment and calculating 44 a driving behavior 46 to be applied depending on the planned driving behavior 18 and the risk 42 of the driving behavior.

A vehicle control device 48 of the vehicle 14 is configured to adjust the driving behavior of the vehicle 14 to be applied depending on the calculated driving behavior 46 to be applied.

The degree of importance 34 and the perception capability 36 are ascertained in particular depending on the driving situation 50, the vehicle environment 22 and environmental conditions 54 of the vehicle 14, resolved into spatial zones 56 of the vehicle environment 22.

The risk 42 of the driving behavior associated with at least one risk event 57 is further ascertained depending on a degree of importance 58 of the risk event, a probability of occurrence 60 of the risk event and a controllability 62 of the risk event.

The risk 42 of the driving behavior is indicated by at least one risk parameter 64. The driving behavior 46 to be applied is calculated so as to deviate from the planned driving behavior 18 if the risk parameter 64 exceeds or falls below a limit value 66.

In addition to the ascertained planned driving behavior 18 as the first driving behavior 68, at least one planned second driving behavior 70 is ascertained, in relation to which planned second driving behavior the risk 40 of functional impairment and the risk 42 of the planned second driving behavior 70 are ascertained analogously to the first driving behavior 68, and the calculation 44 of the driving behavior 46 to be applied includes a selection from the first and second driving behaviors 68, 70 depending on the risk 42 of the driving behavior in question.

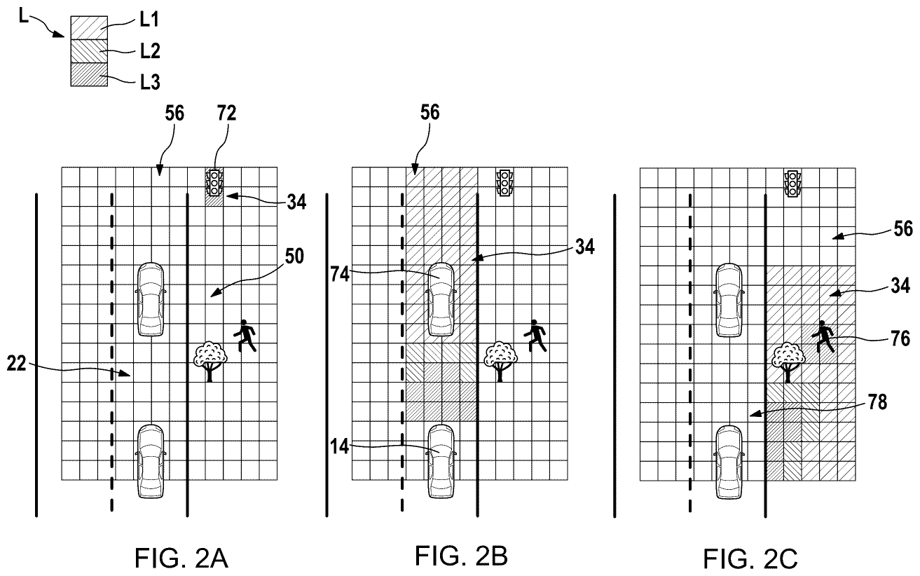

FIGS. 2A to 9C show a particular driving situation when the method for behavior planning is carried out in a further special embodiment of the present invention. FIGS. 2A-2C show the degree of importance 34 of the functional impairment of the environmental perception, which degree of importance is spatially resolved into spatial zones 56 of the vehicle environment 22, for three different environmental perception functions in the same driving situation 50. The spatial zones 56 are designed in a grid structure that is in particular three-dimensional, but is shown here as two-dimensional.

The shown division of the degree of importance into a total of three levels L, a low level L1, a medium level L2 and a high level L3, applies to all figures unless otherwise stated.

In FIG. 2A, the color recognition is shown as an environmental perception function of the environmental perception, in which the degree of importance 34 in the spatial zones 56 of a traffic light 72 takes on the high level L3, while the degree of importance 34 in the surrounding spatial zones 56 is, for example, zero. This means that a functional impairment, for example a malfunction, of the environmental perception in the spatial zones 56 with the highest degree of importance 34 has more serious consequences and therefore a higher risk of the planned driving behavior than in the spatial zones 56 with a medium or low degree of importance L2, L1.

FIG. 2B shows a free space detection as an environmental perception function, in which the degree of importance 34 in the spatial zones 56 immediately in front of the vehicle 14 and between the vehicle 14 and a leading vehicle 74 has the high level L3, further away therefrom the medium level L2 and around the leading vehicle 74 the low level L1.

FIG. 2C shows a lateral motion detection as an environmental perception function, in which the degree of importance 34 in the spatial zones 56 around a person 76 at the edge of the roadway 78 and in the spatial zones 56 to the side of the vehicle 14 has the high level L3.

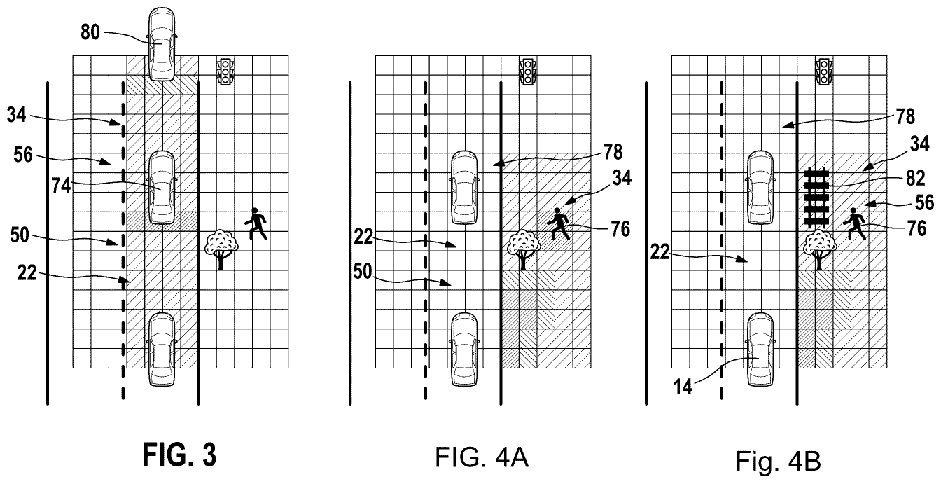

FIG. 3 shows the degree of importance 34 of the functional impairment, which degree of importance is spatially resolved into spatial zones 56 of the vehicle environment 22, in a driving situation 50 in which a leading vehicle 74 is driving in front of the vehicle 14 and in which a further leading vehicle 80 is driving in front of said leading vehicle. The degree of importance 34 in the spatial zones 56 behind the leading vehicle 74 has the high level L3, and in the spatial zones 56 behind the leading vehicle 74 driving further ahead it has the medium level L2. If distance detection is used as an environmental perception function, a functional impairment in the spatial zones 56 having the high degree of importance 34 would have more serious consequences than in the spatial zones 56 having the medium degree of importance 34.

FIGS. 4A and 4B show a driving situation 50 in which a person 76 at the edge of the roadway is moving in the direction of the roadway 78. The driving situation 50 and the vehicle environment 22 shown in FIG. 4A with the gradations of the degrees of importance 34 therein correspond to that of FIG. 2C, while in the vehicle environment 22 in FIG. 4B there is additionally a boundary 82, in particular a fence, between the person 76 and the roadway 78. As a result, the degree of importance 34 of the functional impairment in the spatial zones 56 of the person 76 has the low level L1, so that even a malfunction of the environmental perception in these spatial zones 56 would not have serious consequences in the interaction between the person 76 and the vehicle 14. The conditions in the vehicle environment 22, such as the boundary 82, can be obtained from map data.

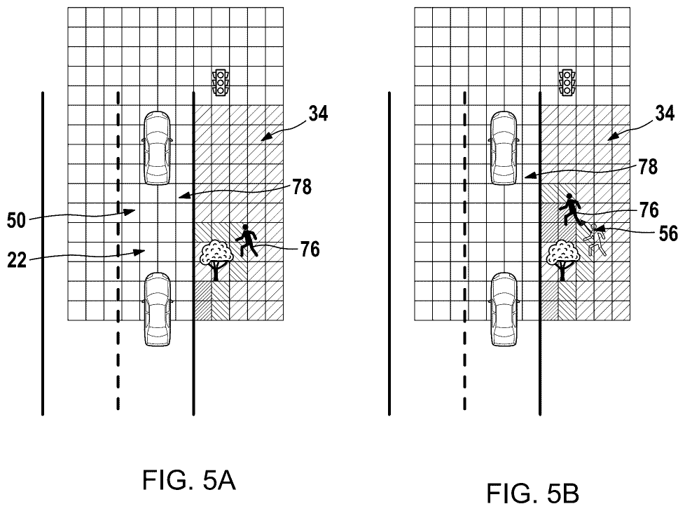

FIGS. 5A and 5B show a driving situation 50 and vehicle environment 22 in which a person 76 is located at the edge of the roadway. In FIG. 5A, the person 76 is further away from the roadway 78 and is moving toward the roadway 78. The degree of importance 34 of the functional impairment depends on the driving situation 50 and the vehicle environment 22. The degree of importance 34 has the medium level L2 in the spatial zones 56 of the person 76, and because the person 76 is getting closer and closer to the roadway 78, as shown in FIG. 5B, the degree of importance 34 of the functional impairment in the spatial zones 56 of the person 76 has the high level L3 after the driving situation 50 in FIG. 5A.

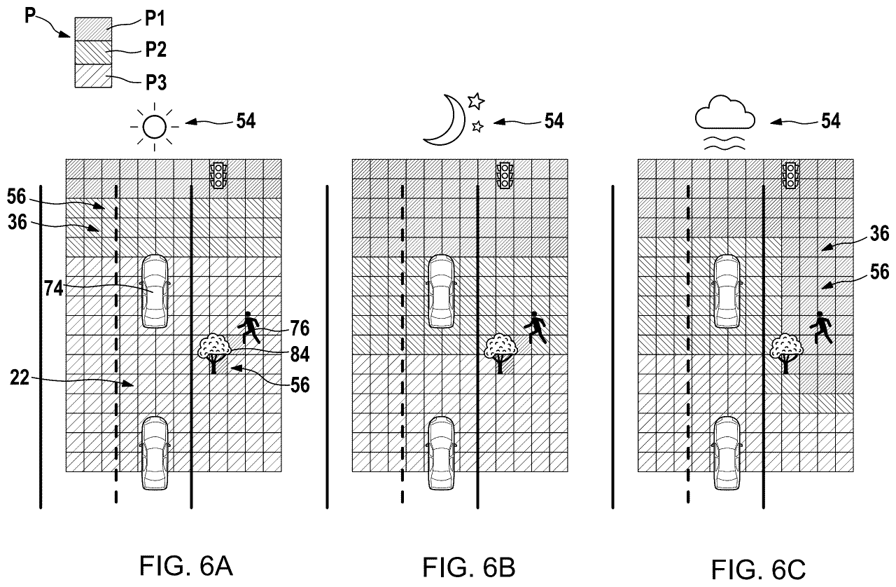

As shown in FIGS. 6A-6C, the perception capability 36 of the environmental perception depends on environmental conditions 54 of the vehicle environment 22. The perception capability 36 is also divided into three levels P, namely a low level P1, a medium level P2 and a high level P3. In FIG. 6A, in good visibility and during daytime, the perception capability 36 in the spatial zones 56 of the leading vehicle 74 and in the spatial zones 56 of the person 76 behind a tree 84 at the edge of the roadway has the lower level P1 than at nighttime as the environmental condition 54, as shown in FIG. 6B. In poor visibility, for example with fog as the environmental condition 56, the perception capability 36 in the same spatial zones 56 is even higher, as shown in FIG. 6C.

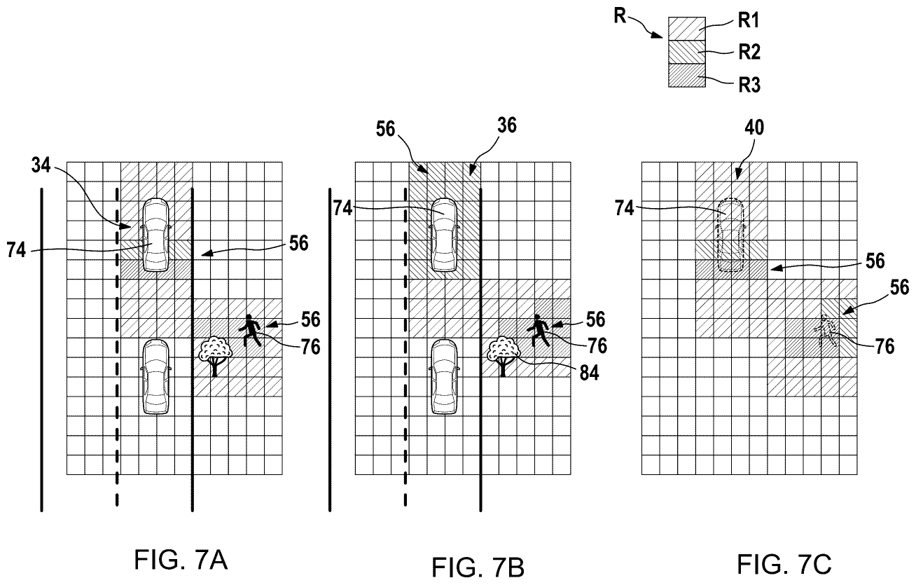

FIG. 7A shows the degree of importance 34 of the functional impairment, FIG. 7B shows the perception capability 36 of the environmental perception, and FIG. 7C shows the risk 40 of the functional impairment of the environmental perception. As shown in FIG. 7A, the degree of importance 34 of the functional impairment in the spatial zones 56 behind the leading vehicle 74 and in the spatial zones 56 of the person 76 has the high level L3. As shown in FIG. 7B, the perception capability 36 has the medium level P2 in the spatial zones 56 around the leading vehicle 74 and the low level P1 behind a tree 84 at the edge of the roadway behind which the person 76 is standing. Accordingly, the risk 40 of functional impairment, divided into three levels R, namely a low level R1, a medium level R2 and a high level R3, as shown in FIG. 7C, has the high level R3 in the spatial zones 56 behind the leading vehicle 74 and in the spatial zones 56 of the person 76, as a function of the degree of importance and the perception capability.

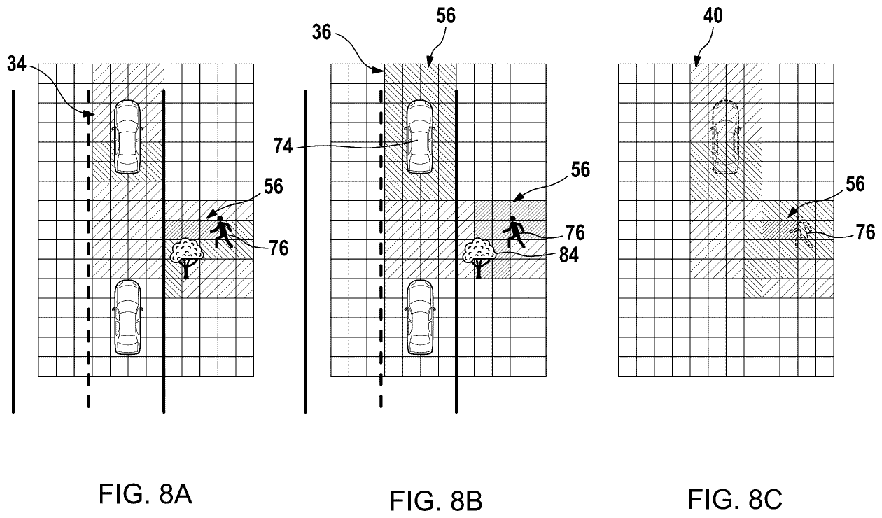

FIG. 8A shows the degree of importance 34 of the functional impairment, FIG. 8B shows a perception capability 36 of the environmental perception, and FIG. 8C shows the risk 40 of the functional impairment of the environmental perception. As shown in FIG. 8C, the degree of importance 34 in the spatial zones 56 of the person 76 and at the edge of the roadway has the high level L3. As shown in FIG. 8B, the perception capability 36 has the medium level P2 in the spatial zones 56 around the leading vehicle 74 and the low level P1 in the spatial zones 56 behind the tree 84 at the edge of the roadway behind which the person 76 is standing. Accordingly, the risk 40 of functional impairment, as shown in FIG. 8C, has the high level R3 in the spatial zones 56 of the person 76, as a function of the degree of importance and the perception capability.

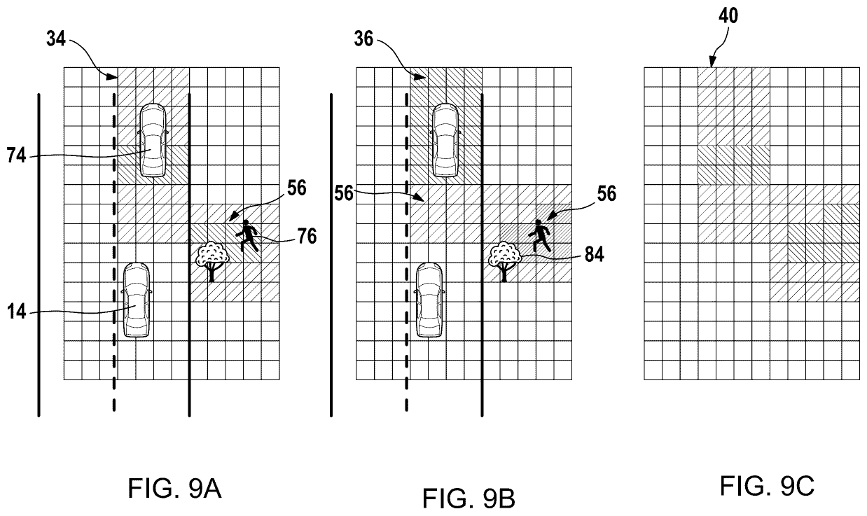

FIG. 9A shows the degree of importance 34 of the functional impairment, FIG. 9B shows a perception capability 36 of the environmental perception, and FIG. 9C shows the risk 40 of the functional impairment of the environmental perception. As shown in FIG. 9A, the degree of importance 34 in the spatial zones 56 of the person 76 and at the edge of the roadway as well as behind the leading vehicle 74 has the medium level L2 because the vehicle 14 is driving further to the left compared to FIG. 8A. Also, the spatial zones 56 having the low level P1 of the perception capability 36 shown in FIG. 9B are offset from those in FIG. 8B behind the tree 84. The risk 40 of functional impairment, as shown in FIG. 9C, has at most the medium level R2, as a function of the degree of importance and the perception capability.

1-10 (canceled)

11. A computer-implemented method for behavior planning of a vehicle, comprising the following steps:
ascertaining at least one planned driving behavior of the vehicle depending on an environmental perception of a vehicle environment of the vehicle;
ascertaining at least one spatially resolved degree of importance of a functional impairment of the environmental perception and a spatially resolved perception capability of the environmental perception, in each case in relation to the planned driving behavior;
ascertaining a risk of the functional impairment of the environmental perception for the planned driving behavior at least depending on a degree of importance and the perception capability;
ascertaining a risk of the planned driving behavior for the vehicle and/or the vehicle environment depending on the risk of the functional impairment; and
calculating a driving behavior to be applied depending on the planned driving behavior and the risk of the planned driving behavior.

12. The computer-implemented method for behavior planning according to claim 11, wherein the degree of importance and/or the perception capability is ascertained depending on a driving situation and/or vehicle environment.

13. The computer-implemented method for behavior planning according to claim 11, wherein the degree of importance and/or the perception capability is ascertained so as to be spatially resolved into spatial zones of the vehicle environment.

14. The computer-implemented method for behavior planning according to claim 11, wherein the degree of importance and/or the perception capability is ascertained depending on environmental conditions of the vehicle.

15. The computer-implemented method for behavior planning according to claim 11, wherein the risk of the driving behavior associated with at least one risk event is further ascertained depending on a degree of importance of the risk event and/or a probability of occurrence of the risk event and/or a controllability of the risk event.

16. The computer-implemented method for behavior planning according to claim 11, wherein the risk of the driving behavior is indicated by at least one risk parameter.

17. The computer-implemented method for behavior planning according to claim 16, wherein the driving behavior to be applied is changed so as to deviate from the planned driving behavior when the risk parameter exceeds or falls below a limit value.

18. The computer-implemented method for behavior planning according to claim 11, wherein at least one planned second driving behavior is ascertained as the first driving behavior, in relation to which planned second driving behavior a risk of functional impairment and a risk of the planned second driving behavior are ascertained analogously to the first driving behavior, and the calculation of the driving behavior to be applied includes a selection from the first and second driving behaviors depending on the risk of the planned driving behavior of the first and second driving behaviors.

19. A processing device for a vehicle, the processing device configured for behavior planning of a vehicle, the processing device configured to:
ascertain at least one planned driving behavior of the vehicle depending on an environmental perception of a vehicle environment of the vehicle;
ascertain at least one spatially resolved degree of importance of a functional impairment of the environmental perception and a spatially resolved perception capability of the environmental perception, in each case in relation to the planned driving behavior;
ascertain a risk of the functional impairment of the environmental perception for the planned driving behavior at least depending on a degree of importance and the perception capability;
ascertain a risk of the planned driving behavior for the vehicle and/or the vehicle environment depending on the risk of the functional impairment; and
calculate a driving behavior to be applied depending on the planned driving behavior and the risk of the planned driving behavior.

20. A vehicle control device for a vehicle, the vehicle control device being configured to adjust a driving behavior of the vehicle to be applied depending on a driving behavior to be applied calculated by performing the following steps:
ascertaining at least one planned driving behavior of the vehicle depending on an environmental perception of a vehicle environment of the vehicle;
ascertaining at least one spatially resolved degree of importance of a functional impairment of the environmental perception and a spatially resolved perception capability of the environmental perception, in each case in relation to the planned driving behavior;
ascertaining a risk of the functional impairment of the environmental perception for the planned driving behavior at least depending on a degree of importance and the perception capability;
ascertaining a risk of the planned driving behavior for the vehicle and/or the vehicle environment depending on the risk of the functional impairment; and
calculating a driving behavior to be applied depending on the planned driving behavior and the risk of the planned driving behavior.
